(19) United States
(12) Patent Application Publication
(10) Pub. No.: US 2013/0083026 A1
(43) Pub. Date: Apr. 4, 2013

(54) Blending Resolution Layers for Fractional Zoom Levels

(71) Applicants: Ann Lethers, Fremont, CA (US); Yasunori Ikeno, Santa Clara, CA (US)

(72) Inventors: Ann Lethers, Fremont, CA (US); Yasunori Ikeno, Santa Clara, CA (US)

(73) Assignee: Olympus Integrated Technologies America, Inc., San Jose, CA (US)

(21) Appl. No.: 13/460,650

(22) Filed: Apr. 30, 2012

Related U.S. Application Data
(63) Continuation of application No. 61/541,843, filed on Sep. 30, 2011.

(51) Int. Cl. G06T 17/00

(52) U.S. Cl. 345/428

(57) ABSTRACT

Systems, devices, and methods can present images that can be viewed at higher and lower levels of resolution, a feature that can be referred to as zooming. Zooming can be enhanced by, for example providing blending of resolution layers for fractional zoom layers. A method can include determining, by a machine, a fractional zoom level to provide based on an input. The method can also include combining at least two integer zoom levels to provide the fractional zoom level. The method can further include providing the fractional zoom level in response to the input.

### CROSS REFERENCE TO RELATED APPLICATIONS

This application is related to, claims the priority of, and incorporates by reference herein the entirety of U.S. Provisional Patent No. 61/541,843, filed Sep. 30, 2011.

### BACKGROUND

1. Field

Systems, devices, and methods can present images that can be viewed at higher and lower levels of resolution, a feature that can be referred to as zooming. Zooming can be enhanced by, for example providing blending of resolution layers for fractional zoom layers.

2. Description of the Related Art

When viewing an image or picture in a software application, a possible difficulty is the size of the image. When the size of an image is beyond the computer virtual memory capacity, the image cannot be loaded into the memory as one unit. To overcome this issue, a large size image can be segmented into smaller tiles with manageable size. Tiles are loaded when an area of image comes into view through panning.

### SUMMARY

A method, according to certain embodiments, includes determining, by a machine, a fractional zoom level to provide based on an input. The method also includes combining at least two integer zoom levels to provide the fractional zoom level. The method further includes providing the fractional zoom level in response to the input.

An apparatus, in certain embodiments, includes a processor configured to determine a fractional zoom level to provide based on an input. The apparatus also includes a combiner configured to combine at least two integer zoom levels to provide the fractional zoom level. The apparatus further includes an image output configured to provide the fractional zoom level in response to the input.

According to certain embodiments, an apparatus includes determining means for determining, by a machine, a fractional zoom level to provide based on an input. The apparatus also includes combining means for combining at least two integer zoom levels to provide the fractional zoom level. The apparatus further includes providing means for providing the fractional zoom level in response to the input.

### BRIEF DESCRIPTION OF THE DRAWINGS

For proper understanding of the invention, reference should be made to the accompanying drawings, wherein:

FIG. 1 illustrates an image pyramid and tiles.

FIG. 2 illustrates a view area with respect to an image pyramid.

FIG. 3 illustrates a higher resolution level tile that is reduced in size to match a fractional zoom level according to certain embodiments.

FIG. 4 illustrates a lower resolution level tile that is increased in size to match a fractional zoom level according to certain embodiments.

FIG. 5 illustrates a blended image resulting from blending the image of FIG. 3 and the image of FIG. 4, according to certain embodiments.

FIG. 6 illustrates the relationship between layers in a pyramid, according to certain embodiments.

FIG. 7 illustrates a viewport width of 1 according to certain embodiments.

FIG. 8 illustrates a viewport width of 2 according to certain embodiments.

FIG. 9 illustrates a viewport width of ¼ or 0.25 according to certain embodiments.

FIG. 10 illustrates a method according to certain embodiments.

FIG. 11 illustrates a system according to certain embodiments.

FIGS. 12A, 12B, 12C, and 12D illustrate blending of tiles according to certain embodiments.

### DETAILED DESCRIPTION

As mentioned above, one approach to handling large images is simply to segment the large image into tiles and load tiles of the image when an area of the image comes into view through panning.

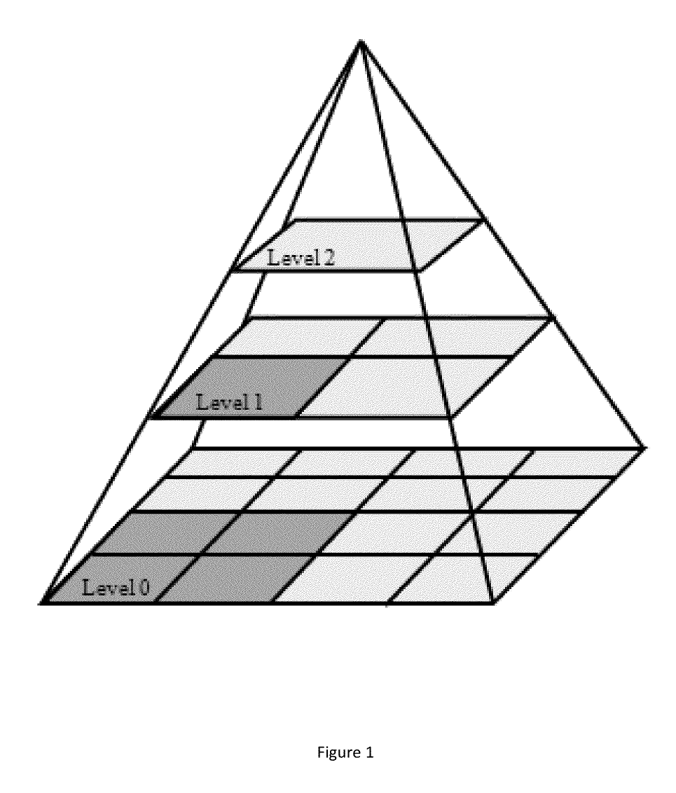

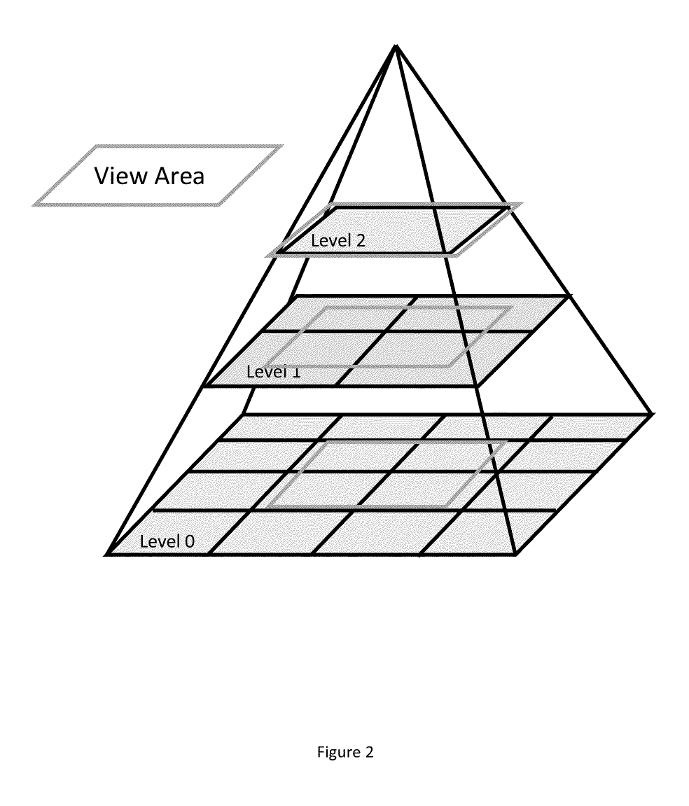

FIG. 1 illustrates an image pyramid and tiles. Rather than simply relying on tiling and panning, another approach is to create an image pyramid of layers to support different levels of resolution detail as shown in FIG. 1. The largest image layer plane at the lower end of the pyramid carries the most detail, whereas the top image layer plane at the top of the pyramid carries the least detail. Combining these two features, an image which is impossible to load into memory at its full size and maximum resolution due to size can be viewed from the lowest resolution level or thumbnail to the highest resolution level through zooming. The number of levels can vary depending on the size of image and resolution detail.

FIG. 2 illustrates a view area with respect to an image pyramid. The initial display of an image can start at the highest pyramid layer which is the lowest resolution level, allowing the entire image to be seen in the computer viewing area, as shown in FIG. 2 at the top level. The zooming feature can allow the next higher resolution to be seen, but only partially.

Thus, for example, at level 2 the whole image is visible in the viewing area, which can also be referred to as the view area, whereas at level 1, only a portion of the image is in the viewing area, and at level 0 even a small portion of the image is in the viewing area, as can be seen in FIG. 2.

More particularly, zooming in from level 2 to level 1 can load tiles in the view area from level 1 into the computer memory. In some cases, only those tiles in the view area can be loaded. In the illustrated example, all four tiles are partially in the view area. Therefore, in this example, all four of the level 1 tiles may be loaded. However, if the zoom were to a single quadrant of layer 1, only the corresponding tile may be loaded.

The same process can repeated for zooming from level 1 to level 0. As can be seen, in the zoom to level 0, it is not necessary to load all of the tiles for level 0, but it is sufficient to load the four centermost tiles.

A reverse process can be done for zooming out from level 0 to level 1 or from level 1 to level 2. Although only three levels are shown in this example, it is possible for many more integer levels of zoom to exist, depending on a variety of factors, such as the size of the overall image and the number of integer levels of tiles to be stored.

When zooming in from level 1 to level 0.5, there is no exact corresponding level of tiles to load. In other words, fractional levels can be those levels between levels for which there are tiles that exist. These contrast to so-called integer levels where there is a set of tiles that exist.

To address fractional zoom levels, there are various possible approaches. For example, in the case of level 0.5 a system can use level 1 tiles and enlarge them by 1.5 times for 0.5 zoom level. Alternatively, the system can use level 0 tiles and reduce them by 0.5 times for 0.5 zoom level.

Moreover, there are at least three ways choose the resolution level for a specific zoom level. A first approach is to favor the lower resolution level. In this case, the system uses the enlarged lower resolution level all the way until the next higher resolution level is reached. For example, if the zoom level is 0>Zoom≧1, the system can use level 1 and enlarge it as necessary. A second approach is to favor the higher resolution level. In this case, the system uses the reduced higher resolution level all the way until the level itself is reached. For example, if the zoom level is 0≧Zoom>1, the system can use level 0 and reduce it as necessary. A third approach is to define a threshold, for example 0.5. If the zoom level is less than the threshold, the system can use the enlarged lower resolution level. Then, the system can switch to the higher resolution level once the threshold is reached or passed.

The same principle can be applied to the zoom out condition. Alternatively, the approach for zooming in and for zooming out can be different. For example, when zooming in the first approach can be used and when zooming out the second approach can be used, or different thresholds can be used in different directions of zoom.

The mechanisms described above do not actually represent an in-between layer, but rather one or the other of the integer layers. Thus, the layer may show more or less detail than a user desires, depending on the mechanism used. Moreover, there may be a loss of subtlety and trueness of the layer in between.

To achieve a better approximation of a resolution level for a level or layer in between two levels, namely a fractional zoom level, instead of using just one pyramid layer, two pyramid layers may be used. After the lower resolution layer is enlarged and the higher resolution layer is shrunk to the same size for the zoom level, the two images are blended together. The opacity of the layers is set based on the requested zoom level. The layer closer to the zoom level has higher opacity value, so more detail on this layer is shown.

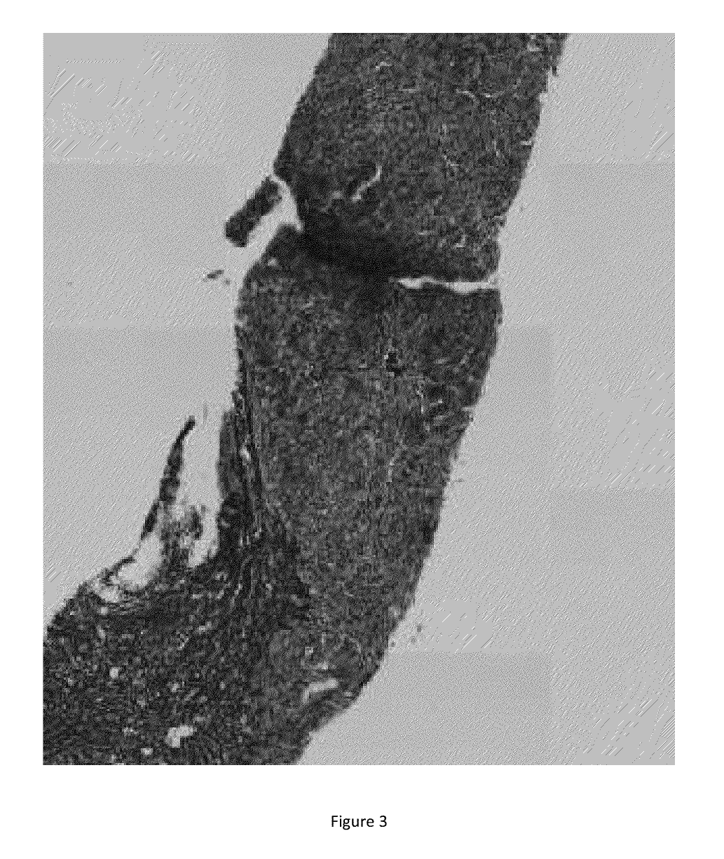

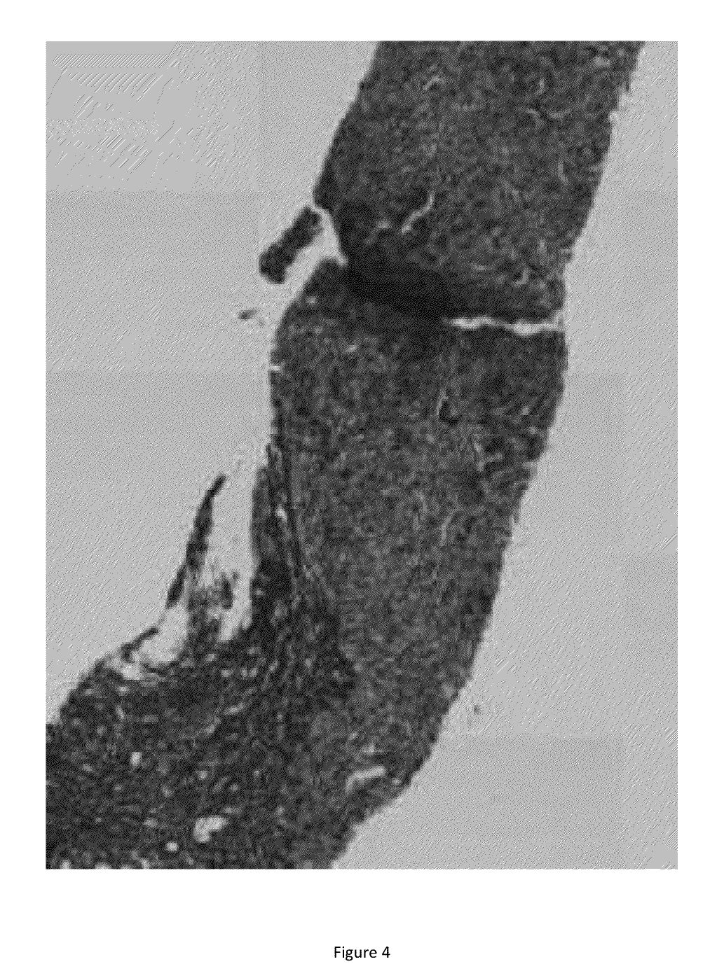

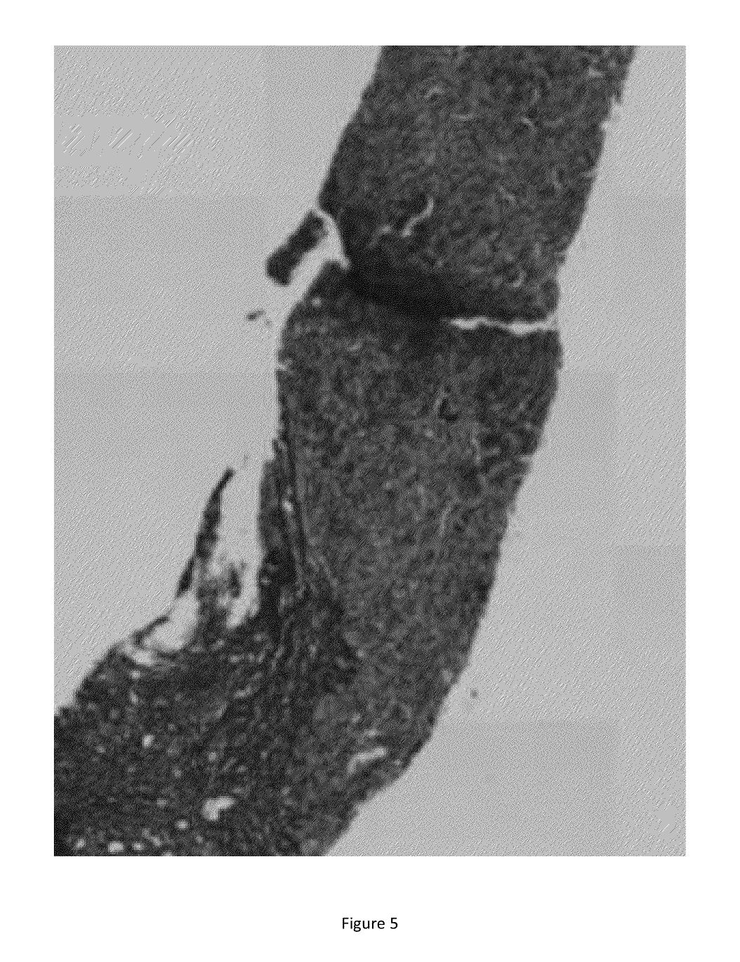

FIGS. 3-5 illustrate the combination of two integer levels to form a fractional zoom level. FIG. 3 illustrates a higher resolution level tile that is reduced in size to match a fractional zoom level, FIG. 4 illustrates a lower resolution level tile that is increased in size to match a fractional zoom level according to certain embodiments, and FIG. 5 illustrates a blended image resulting from blending the image of FIG. 3 and the image of FIG. 4, according to certain embodiments.

For example, the fractional zoom level can be 3.49. In this case, the higher resolution layer can be given an opacity value of 0.49 and the lower resolution layer can be given an opacity value of 0.51, meaning that the lower resolution layer is slightly more opaque than the higher resolution layer. This selection can be based on the desired zoom level of 3.49 being closer to the lower resolution level. Thus, in FIG. 3 a higher resolution level tile is reduced in size to match 3.49 zoom level. Meanwhile, in FIG. 4 a lower resolution level tile is enlarged in size to match 3.49 zoom level. Then, in FIG. 5 both images are blended with different opacity values.

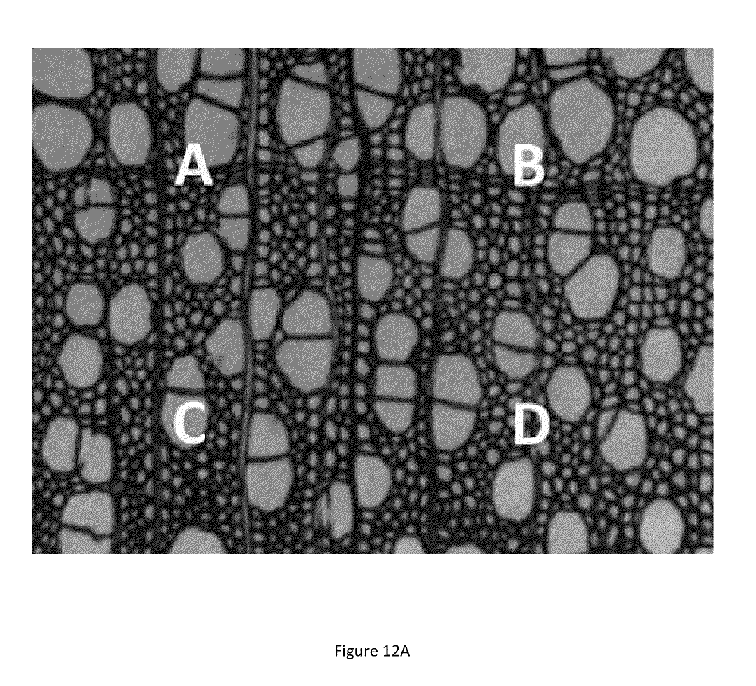

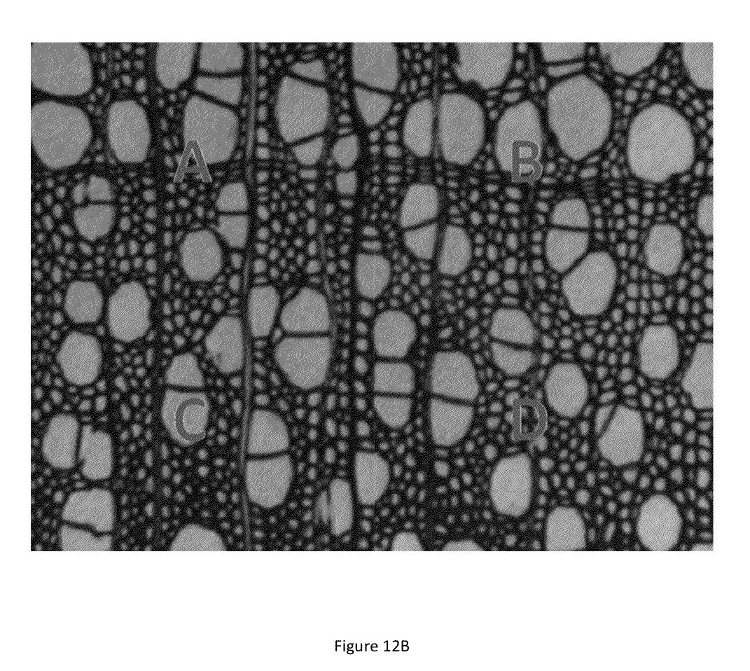

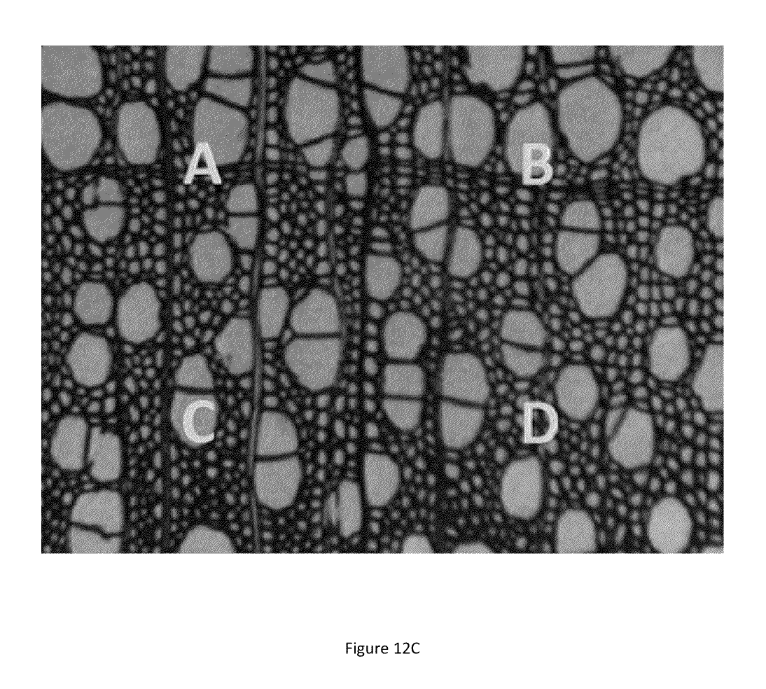

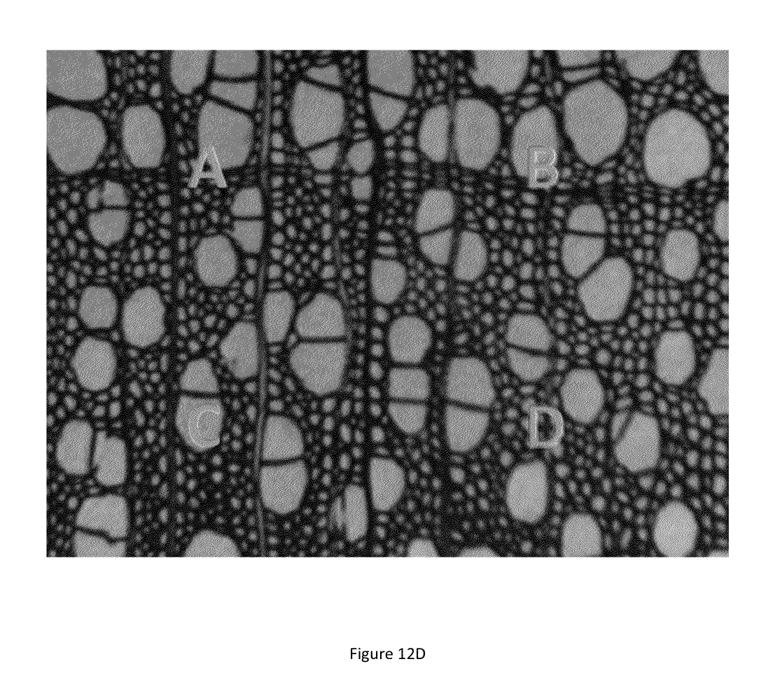

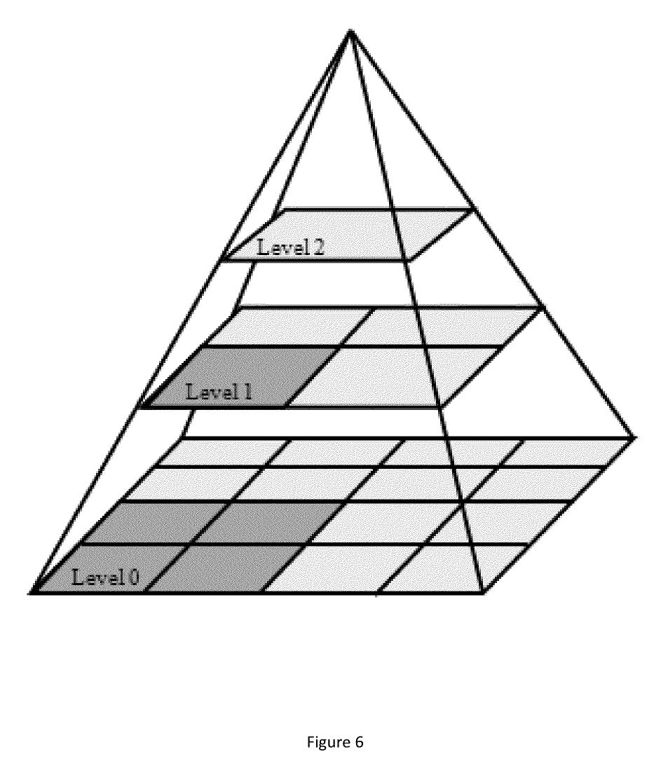

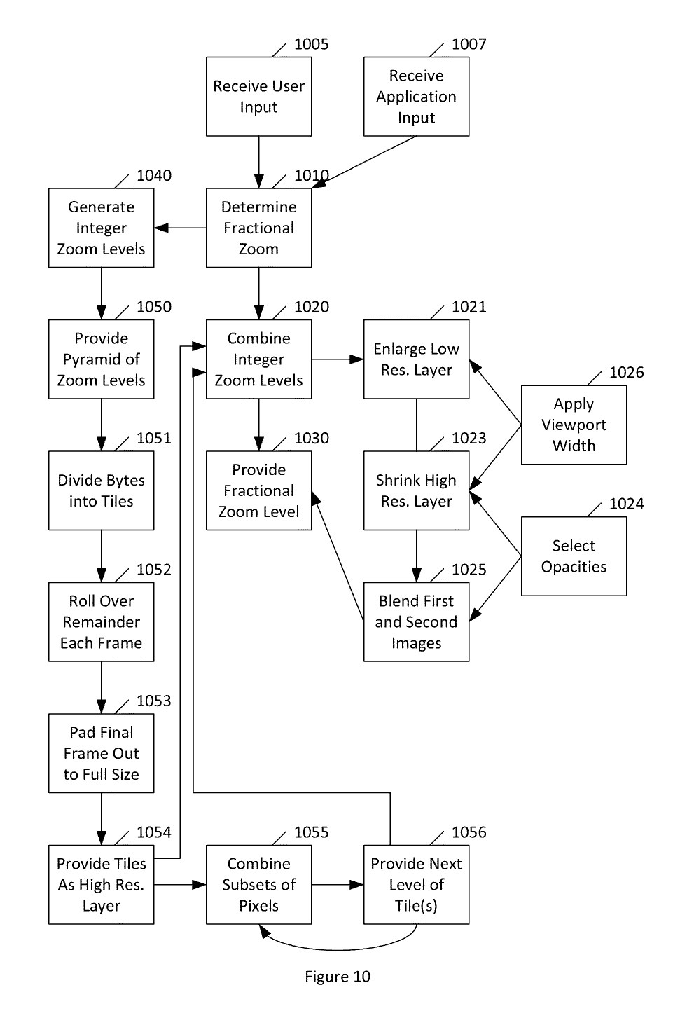

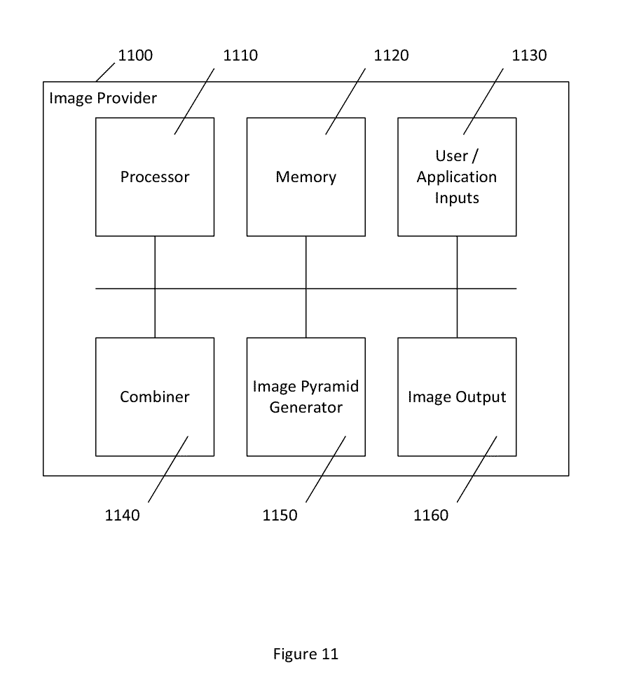

FIGS. 12A, 12B, 12C, and 12D illustrate blending of tiles according to certain embodiments. For example, in FIG. 12A a single tile with a first zoom level is shown, with light colored letters. The light colored letters are simply provided to help illustrate the principle. In FIG. 12B, by contrast, a set of four tiles with dark color letters with a second zoom level, joined by seams, are shown. In FIG. 12C, the images of FIGS. 12A and 12B have been blended to obtain a zoom about mid-way between. The shading of the letters is consequently medium. Not only the letters are affected, but the letters may show this most visibly. FIG. 12D represents a zoom closer to FIG. 12B. Therefore, the shading of the figures is closer to that of FIG. 12B, than to that of FIG. 12A.

The blending described above can be performed in a variety of ways using a variety of tools. For example, the Deep Zoom technology found within Silverlight™ of Microsoft (MS) Corporation of Redmond, Wash., can be used or modified to achieve this blending feature. There are can be two parts of this technology. A first part can be to generate tile image pyramid for a given image and the second part is to render the image using generated tile image pyramid. MS provides a tool to generate a tile image pyramid, called Deep Zoom Composer. The control MS provides that can render an image is called Multi-Scale Image (MSI).

However, the MS Deep Zoom Composer in the first part above has limited features. Accordingly, a similar tool can be provided, which can be configured to generate the tiles and tile pyramid structure and to provide an output that fulfills the MSI requirements in order to render images.

Specifically, the tool to generate tiles can, while a scanning tool is scanning each site under a microscope for a medical slide in one example, acquire camera frame in byte array for every site. The bytes can be divided into 512×512 pixel square tiles. At the end of a frame, if there are not enough bytes for a 512×512 tile, the remaining bytes can be rolled over into the next frame so that those bytes are combined with the first bytes of the next frame to produce a next tile. When it is the last frame, the tool can pad any space for which the bytes did not provide data with some background color pixels. For example, white pixels can be used as background color pixels. When this process is complete, the collection of 512×512 tiles can serve as the highest resolution level or layer. This can correspond to level 0 in the pyramid described above. The selection of 512×512 is just one example. It is possible to use non-square tiles or tiles with other numbers of pixels, such as 1024×1024 tiles.

Then, the tool can take the highest resolution layer pixels, combine every 2×2 square pixels into one pixel. This process can be continued until a 512×512 square is generated. This square can be saved as a tile for the next coarse layer. The process can be repeated until the end of entire highest resolution layer is reached. The resulting set of tiles can form the next layer of the tile pyramid. So by giving the Level 0 size, the rest of layer sizes can be calculated as Level×Width=Level0Width/2^{x} and Level×Height=Level0Height/2^{x}.

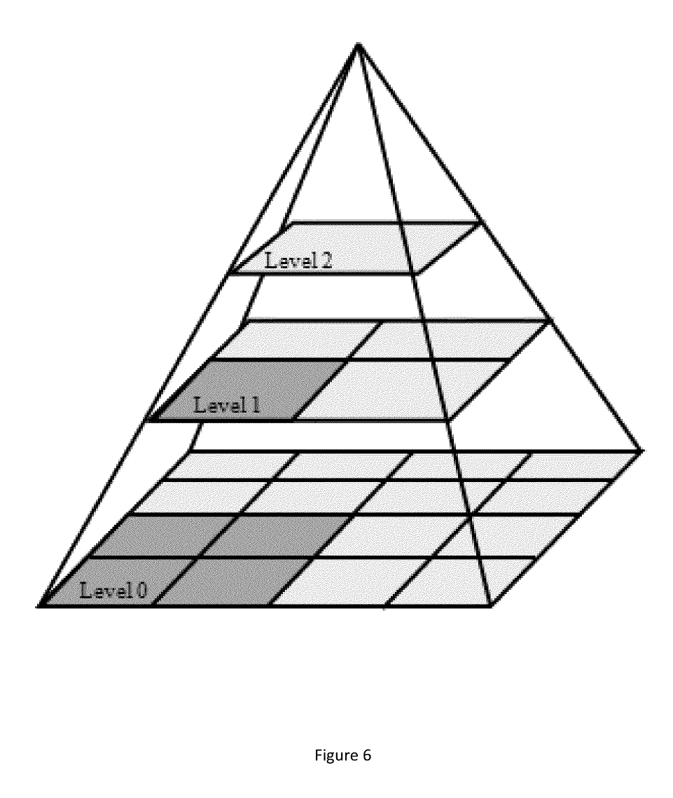

FIG. 6 illustrates the relationship between layers in a pyramid, according to certain embodiments. More particularly, FIG. 6 illustrates how four level 0 tiles can serve as the basis for one level 1 tile.

The same process can be repeated until the level has only one tile. In FIG. 6, the level with only one tile is level 2, but there can be many more than three levels, depending on factors such as the size of the high resolution image. The tile data can be stored in a preparatory image file. Each slide image can have its own image file.

Rendering an image can be performed in a variety of ways. For example, the system can use the MS Silverlight™ control, Multi-Scale Image (MSI) to display images. Other tools can also be used, with this tool serving simply as an example.

When the tile source of MSI is defined or given, the actions can start. The sequence of events can be as described below. MSI can request the tile source for the tile's URL, one tile at a time, through a function called “GetTile”. The passed in arguments for this function can include row, column, and resolution level for a specific tile. These three values can define the tile position in a tile pyramid structure uniquely.

The “GetTile” function can compile the content of the URL with the passed in arguments and other data obtained in the application. The content of the URL can be, for example, the address of the location of another function to perform the actual tile retrieval. This value can point to a physical image, for example, .jpg, .bmp, .gif, .tiff, .jpeg, .png, or .pnr file. The URL can also include the name of the slide image file. Moreover, the URL can include the tile's row, column, and resolution level values. The URL may also include other information.

The URL can serve as part of a process to invoke the function and to pass in the arguments to the function. After code execution, a byte array can be returned to MSI. The byte array can be translated by MSI into an image to display.

In certain embodiments, the URL can contain simply an address to an image file, C:\MyImage.jpg for example. MSI can open the file to get the image byte array automatically.

ViewportWidth can refer to one of MSI's application programming interfaces (APIs) that the user can get and set. More specifically, the viewport width can be a value. Every time when this value is changed, the change in value can trigger MSI to get tiles.

Viewport width can refer to the width of an area of the image displayed. It can be expressed as a relative value with respect to the layer of an image.

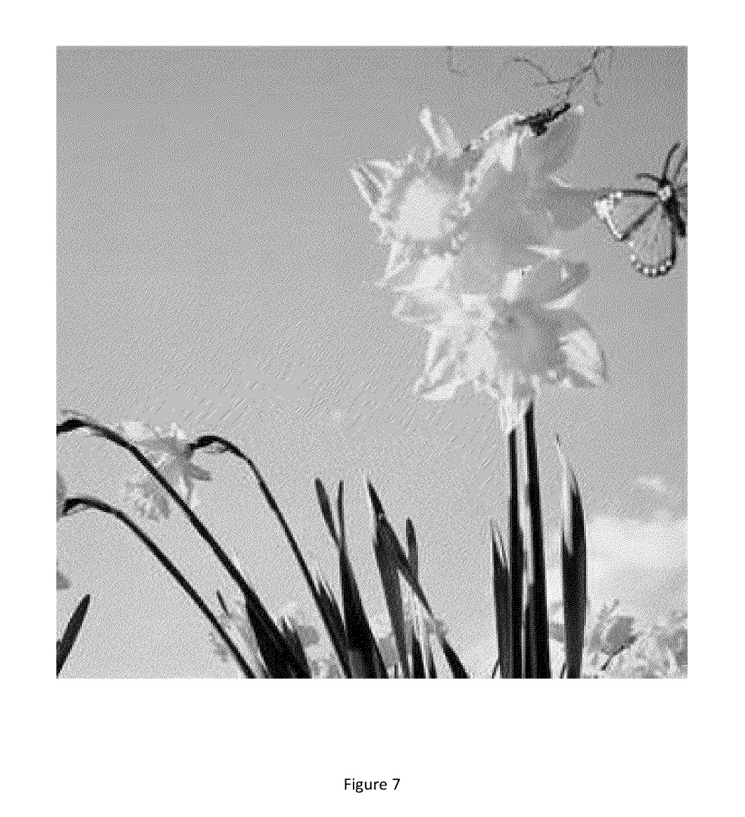

FIG. 7 illustrates a viewport width of 1 according to certain embodiments. In FIG. 7, the window is displaying the entire image. Therefore, the viewport width equals 1.

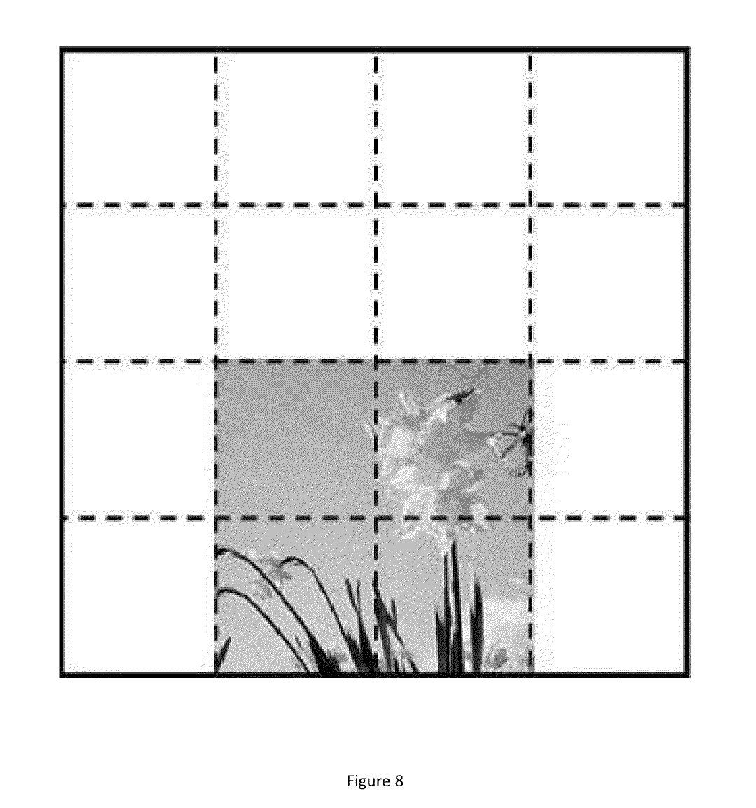

FIG. 8 illustrates a viewport width of 2 according to certain embodiments. In FIG. 8, the window width can be 800 pixels, but the image width can be 400 pixels. Thus, the window's width is twice the width of the image. So, the viewport width is 2. A more general formula to calculate the viewport width can be as follows: viewport width=window width/image width.

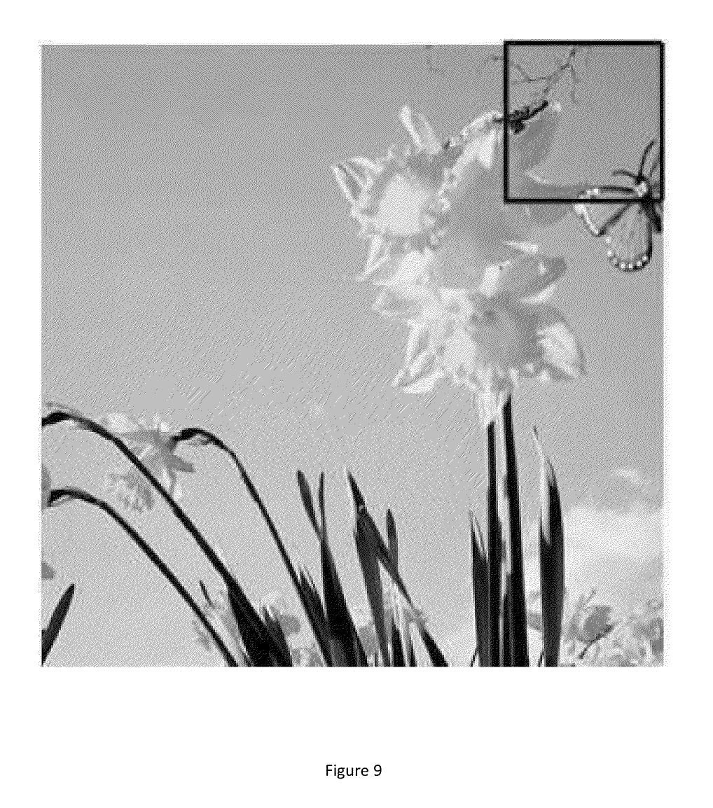

FIG. 9 illustrates a viewport width of ¼ or 0.25 according to certain embodiments. In this example, a window width can be 800 pixels as in FIG. 8, but in this case the image width can be 3200 pixels. Using the formula above, the viewport width is 0.25. When the image width is bigger than the window width, the viewport width value will, in view of the formula, be between 0 and 1.

In view of the relationship between viewport width and window size, zoom in and zoom out of an image can be produced by setting the viewport width value for MSI.

To produce an effect of two layer blending while zooming, a zoom level value can be set to a fractional value. The value for a displayed image is the window's width, which can be defined by the software. Zoom level can be a value that the user can request, either by typing on the keyboard, moving a mouse wheel, or moving one or more fingertip or stylus on a tactile input device, such as a touch-sensitive screen. The system can capture this value.

Based on the following formula, in which x is the zoom level, the zoom level's image width can be calculated as level widthₓ=level width₀/2′.

Using the result from above for the image width, the viewport width can be calculated as viewport width=window width/level widthₓ.

Accordingly, the system can set MSI's viewport width value to the result from the above calculation, which can trigger MSI to get tiles from both resolution layers, one above the current zoom level and one below the current zoom level, resize both layers to the current zoom level, and finally change the opacities.

Hence, MSI's viewport width can be set for any zoom level including fractional values. Internally, MSI can calculate the new zoom level with the value of viewport width. When it is not a level corresponds to any physical tile level, an operation of blending two layers of tiles can be performed.

Thus, certain embodiments can avoid a limitation that the zoom value is restricted to an integer value. Thus, certain embodiments can assist in selecting a best fit size of an image for the displaying window or using a mouse wheel to zoom in and out of an image by a small increment or decrement.

Certain embodiments provide a method using the viewport width to provide a more accurate and true image representation of zoom levels that fall in between pyramidal structure image layers. Moreover, certain embodiments utilize the zooming layer blending feature to achieve user desired zoom level without restriction and improve user experience.

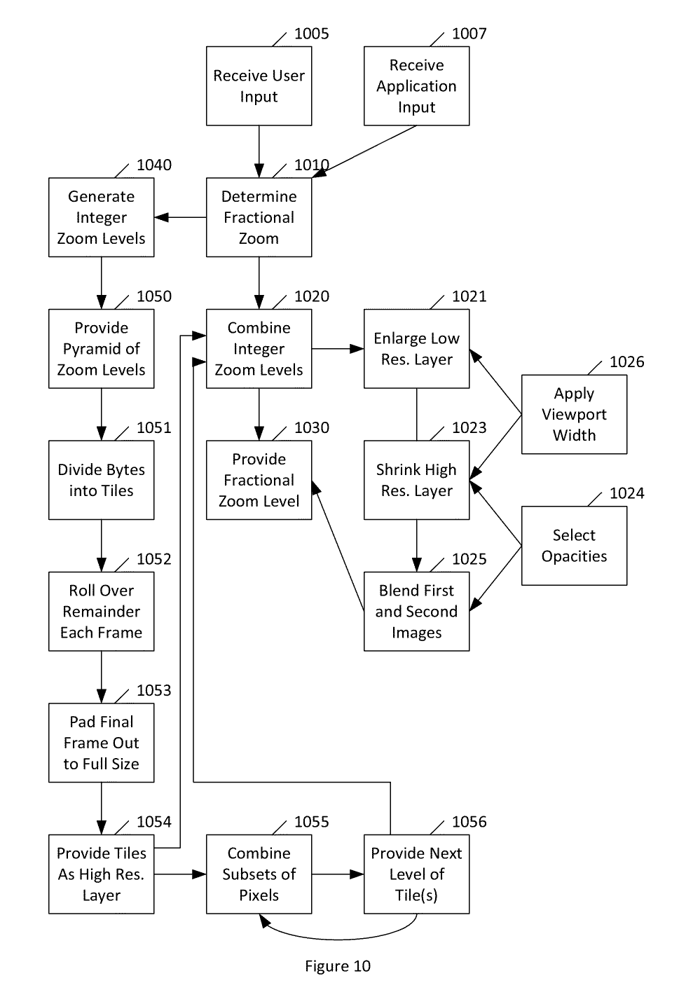

FIG. 10 illustrates a method according to certain embodiments. As shown in FIG. 10, a method can include, at 1010, determining, by a machine, a fractional zoom level to provide based on an input. The method can also include, at 1020, combining at least two integer zoom levels to provide the fractional zoom level. The method can further include, at 1030, providing the fractional zoom level in response to the input.

The combining can include, at 1021, enlarging a first image of a lower resolution layer corresponding to a first integer zoom level. The combining can also include, at 1023, shrinking a second image of a higher resolution layer corresponding to a second integer zoom level. The combining can further include, at 1025, blending the first image and the second image together to provide the fractional zoom level.

The enlarging and the shrinking are performed by, at 1026 applying a first viewpoint width to an image of a first integer zoom level and a second viewpoint width to an image of a second integer zoom level. The combining can additionally, include, at 1024, selecting an opacity for each of the integer zoom levels. A first layer closer to the fractional zoom level can be selected to have higher opacity value and a second layer farther from the fractional zoom level can be selected to have a lower opacity value.

The method can also include, at 1040, generating the at least two integer zoom levels from an original high resolution image. The generating can include, at 1050, providing a pyramid of zoom levels having a fixed relationship between the levels based on pixel combination.

The generating can more particularly include, at 1051, dividing bytes into regular tiles of a predetermined size; rolling over, at 1052, any remainder bytes to a next frame; padding, at 1053, any remainder in a last tile of a last frame; and providing, at 1054, the regular tiles as a highest resolution layer of the pyramid.

The generating can further include, at 1055, combining regular subsets of pixels of the highest resolution layer and, at 1056, providing tiles composed of pixels resulting from the combination as a second level of the pyramid. These generating procedures can be repeated until a pyramid of several or many levels is complete.

The method can also include, at 1005, receiving the input from a user, wherein the input includes a user-selected zoom level. The method can further include, at 1007, receiving the input from an application, wherein the input includes a window size of the application.

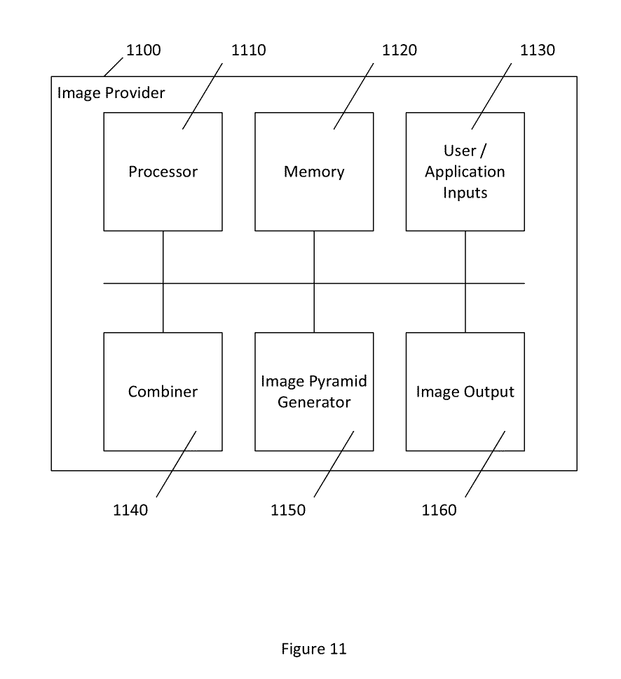

FIG. 11 illustrates a system according to certain embodiments. As shown in FIG. 11, a system can be or include an image provider 1100. The image provider 1100 can be implemented in a variety of ways, including in hardware alone or in software running on hardware. The image provider 1100, in certain embodiments can include at least one processor 1110, which can be a controller, a central processing unit (CPU) or a graphics processing unit (GPU), among other things. A multi-core processor can be used in certain embodiments. The system can also include at least one memory 1120, which can be buffer memory, memory on a chip, or memory in the form of a hard disk drive. Other kinds of memory are also permitted. The memory can be a non-transitory computer-readable medium. The system can also include user and application inputs 1130. For example, a user interface can permit a user to provide an input of a desired zoom level, or an application can provide a specific window size as an input.

The system can further include a combiner 1140. The combiner 1140 can be configured to combine images to provide a fractional zoom level, using the processes described above. Likewise, the system can include an image pyramid generator 1150, which can receive, for example, a byte stream as an input and can output sets of tiles corresponding to a pyramid of integer zoom layers. The system may further be equipped with an image output 1160, which can provide an image to an application or present the image to a graphical user interface.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY OF ABBREVIATIONS

MS—Microsoft Corporation of Redmond, Wash.

MSI—Multiple Scale Image control.

API—Application Programming Interface, which can refer to a set of interface methods to facilitate the interaction between software programs.

We claim:

1. A method, comprising:
determining, by a machine, a fractional zoom level to provide based on an input;
combining at least two integer zoom levels to provide the fractional zoom level; and
providing the fractional zoom level in response to the input.

2. The method of claim 1, wherein the combining comprises
enlarging a first image of a lower resolution layer corresponding to a first integer zoom level,
shrinking a second image of a higher resolution layer corresponding to a second integer zoom level, and
blending the first image and the second image together to provide the fractional zoom level.

3. The method of claim 1, wherein the combining comprises selecting an opacity for each of the integer zoom levels.

4. The method of claim 3, wherein the selecting includes selecting, for a first layer closer to the fractional zoom level, a higher opacity value and, for a second layer farther from the fractional zoom level, a lower opacity value.

5. The method of claim 1, further comprising:
generating the at least two integer zoom levels from an original high resolution image, wherein the generating comprises providing a pyramid of zoom levels having a fixed relationship between the levels based on pixel combination.

6. The method of claim 5, wherein the generating comprises
dividing bytes into regular tiles of a predetermined size;
rolling over any remainder bytes to a next frame;
padding any remainder in a last tile of a last frame; and
providing the regular tiles as a highest resolution layer of the pyramid.

7. The method of claim 6, wherein the generating further comprises
combining regular subsets of pixels of the highest resolution layer; and
providing tiles composed of pixels resulting from the combination as a second level of the pyramid.

8. The method of claim 2, wherein the enlarging and the shrinking are performed by applying a first viewpoint width to an image of a first integer zoom level and a second viewpoint width to an image of a second integer zoom level.

9. The method of claim 1, further comprising:
receiving the input from a user, wherein the input comprises a user-selected zoom level.

10. The method of claim 1, further comprising:
receiving the input from an application, wherein the input comprises a window size of the application.

11. An apparatus, comprising:
a processor configured to determine a fractional zoom level to provide based on an input;
a combiner configured to combine at least two integer zoom levels to provide the fractional zoom level; and
an image output configured to provide the fractional zoom level in response to the input.

12. The apparatus of claim 11, wherein the combiner is further configured to
enlarge a first image of a lower resolution layer corresponding to a first integer zoom level,
shrink a second image of a higher resolution layer corresponding to a second integer zoom level, and
blend the first image and the second image together to provide the fractional zoom level.

13. The apparatus of claim 11, wherein the combiner is configured to select an opacity for each of the integer zoom levels.

14. The apparatus of claim 13, wherein the combiner is configured to select, for a first layer closer to the fractional zoom level, a higher opacity value and, for a second layer farther from the fractional zoom level, a lower opacity value.

15. The apparatus of claim 11, further comprising:
an image pyramid generator configured to generate the at least two integer zoom levels from an original high resolution image, and to provide a pyramid of zoom levels having a fixed relationship between the levels based on pixel combination.

16. The apparatus of claim 15, wherein the image pyramid generator is configured to
divide bytes into regular tiles of a predetermined size;
roll over any remainder bytes to a next frame;
pad any remainder in a last tile of a last frame; and
provide the regular tiles as a highest resolution layer of the pyramid.

17. The apparatus of claim 16, wherein the image pyramid generator is further configured to
combine regular subsets of pixels of the highest resolution layer; and
provide tiles composed of pixels resulting from the combination as a second level of the pyramid.

18. The apparatus of claim 12, wherein the combiner is configured to enlarge and shrink images by applying a first viewpoint width to an image of a first integer zoom level and a second viewpoint width to an image of a second integer zoom level.

19. The apparatus of claim 11, a user input configured to receive the input from a user, wherein the input comprises a user-selected zoom level.

20. The apparatus of claim 11, an application input configured to receive the input from an application, wherein the input comprises a window size of the application.

21. An apparatus, comprising:
determining means for determining, by a machine, a fractional zoom level to provide based on an input;
combining means for combining at least two integer zoom levels to provide the fractional zoom level; and
providing means for providing the fractional zoom level in response to the input.
